(19) United States
(12) Patent Application Publication
(10) Pub. No.: US 2020/0177001 A1
(43) Pub. Date: Jun. 4, 2020

(54) CONTROL APPARATUS AND CONTROL SYSTEM

(71) Applicant: FUJITSU CLIENT COMPUTING LIMITED, Kanagawa (JP)

(72) Inventors: Hirotaka Yakame, Kanagawa (JP); Taketoshi Hayashi, Osaka (JP)

(73) Assignee: FUJITSU CLIENT COMPUTING LIMITED, Kanagawa (JP)

(21) Appl. No.: 16/671,838

(22) Filed: Nov. 1, 2019

(30) Foreign Application Priority Data
Nov. 30, 2018 (JP) 2018-225214

(51) Int. Cl. H02J 7/00; G06F 1/18; G06F 1/16; H01R 13/717; H05B 33/08; G08B 5/36

(52) U.S. Cl. CPC H02J 7/0021; G06F 1/189; G06F 1/1632; H01R 24/60; H02J 7/0045; H05B 33/0842; G08B 5/36; H01R 13/7175

(57) ABSTRACT

A control apparatus includes: an interface part to which a second connector part of a cable is connectable, wherein the cable includes a first connector part that is connected to an information processing apparatus and the second connector part provided on the opposite side of the first connector part, the first connector part is provided with a first indicator lamp; and a control circuit that acquires, from the information processing apparatus via the cable and the interface part, first information indicating a state related to charging of the information processing apparatus, and perform light control of the first indicator lamp in accordance with the first information.

### CROSS-REFERENCE TO RELATED APPLICATIONS

This application is a based upon and claims the benefit of priority from Japanese Patent Application No. 2018-225214 filed on Nov. 30, 2018, the entire contents of which are incorporated herein by reference.

### TECHNICAL FIELD

Embodiments described herein relate generally to a control apparatus and a control system.

### BACKGROUND

A cable that is capable of delivering power may be connected to an information processing apparatus such as a personal computer. Such a cable allows for power delivery to and charging of the information processing apparatus.

### SUMMARY

However, if an information processing apparatus is not charged sufficiently due to a cable connection failure or other defects, the information processing apparatus may not be available when it is needed for use. It is desired to correctly grasp a state related to charging of an information processing apparatus.

According to one aspect of the present disclosure, a control apparatus including an interface part and a control circuit. To the interface part, a second connector part of a cable is connectable. The cable includes a first connector part and the second connector part. The first connector part is a part to be connected to an information processing apparatus. The second connector part is arranged on an opposite side of the first connector part. A first indicator lamp is provided on the first connector part. The control circuit is configured to acquire, from the information processing apparatus via the cable and the interface part, first information indicating a state related to charging of the information processing apparatus. The control circuit is configured to perform light control of the first indicator lamp in accordance with the first information.

### BRIEF DESCRIPTION OF THE DRAWINGS

FIGS. 1A and 1B are views illustrating an external configuration of a chargeable cabinet in a control system according to an embodiment;

FIG. 2 is a view illustrating a circuit configuration of the control system according to the embodiment;

FIG. 3 is a view illustrating a circuit configuration (when a connector part is connected in reverse) of the control system according to the embodiment;

FIGS. 4A and FIG. 4B are views illustrating terminal configurations of an interface part and a connector part according to the embodiment;

FIG. 5 is a view illustrating operation (for light control of an indicator lamp) of the control system according to the embodiment;

FIG. 6 is a view illustrating operation (for light control of another indicator lamp) of the control system according to the embodiment;

FIG. 7 is a flow chart illustrating operation of the control system according to the embodiment; and

FIG. 8 is a view illustrating a connection configuration of the control system according to a modification of the embodiment.

### DETAILED DESCRIPTION

The following describes in detail an embodiment of a control system disclosed in the present application with reference to the accompanying drawings. It should be noted that this embodiment is not intended to limit the disclosed techniques. Like reference numerals indicate like components in the embodiment and overlapping explanation is omitted.

### Embodiments

A control system according to an embodiment controls charging of an information processing apparatus such as a personal computer in a chargeable cabinet. Examples of the personal computer include a portable tablet computer, electronic paper, and other devices. In a chargeable cabinet, a cable that is capable of delivering power may be connected to an information processing apparatus such as a personal computer. The cable capable of delivering power may be a universal serial bus (USB) cable or a USB Type-C cable conforming to the USB-C standard. This cable allows for communication of information to the information processing device as well as power delivery to and charging of the information processing apparatus. USB Type-C connectors (or USB-C connectors) of a USB Type-C cable are general-purpose thin connectors that support USB/DisplayPort signals and power supply. The connectors serve as interfaces that can efficiently connect the information processing apparatus with a control apparatus. This cable allows for communication of information to the information processing apparatus as well as power delivery to and charging of the information processing apparatus in a collective manner.

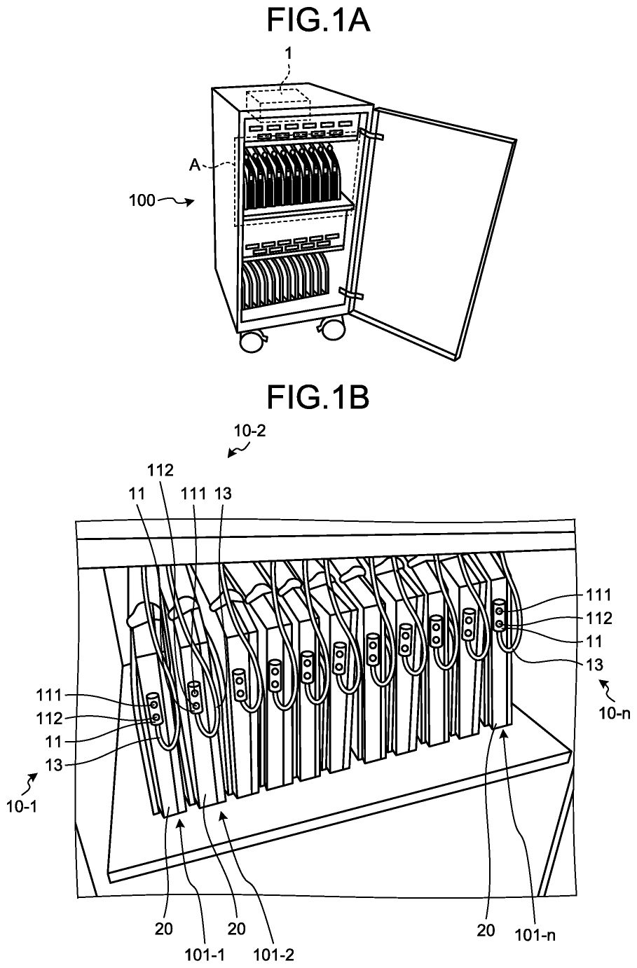

For example, on a site such as a school that operates a substantial number of information processing apparatuses, a chargeable cabinet 100 as illustrated in FIG. 1A may be used.

FIG. 1A is a perspective view illustrating an external configuration of the chargeable cabinet 100 and FIG. 1B is a perspective view illustrating enlarged part A in FIG. 1A.

As illustrated in FIGS. 1A and FIG. 1B, the chargeable cabinet 100 includes a control apparatus 1, a plurality of housing spaces 101-1 to 101-n (n is any integer equal to or larger than 2), and a plurality of cables 10-1 to 10-n. Each of the housing spaces 101-1 to 101-n is a space that can store therein an information processing apparatus 20. The cables 10-1 to 10-n are provided corresponding to the housing spaces 101-1 to 101-n, respectively, and are connectable to information processing apparatuses 20 stored in respective housing spaces 101. Each cable 10 (a USB cable, for example) is capable of delivering power and is electrically connected to the control apparatus 1. The control apparatus 1 is capable of charging the information processing apparatuses 20 by supplying power to the information processing apparatuses 20 via the respective cables 10. That is, the control apparatus 1 and the cables 10-1 to 10-n constitute a control system 30 for controlling charging of the information processing apparatuses 20.

This control system 30 is capable of charging the information processing apparatuses 20 at the same time from the control apparatus 1 via the cables 10 when the cables 10 are connected to the information processing apparatuses 20.

However, when the chargeable cabinet 100 is used, problems such as the following (1) and (2) may be encountered on the site:
(1) A connection failure (insertion failure) of the cable 10 may occur when a user stores the information processing apparatus 20 in the chargeable cabinet 100.
(2) The information processing apparatus 20 may have not been charged when a user takes out the information processing apparatus 20 from the chargeable cabinet 100 to use it (the charging state of the information processing apparatus 20 is unknown when the information processing apparatus 20 is taken out of the chargeable cabinet 100).

A possible solution to solve these problems is to provide near a USB port of the information processing apparatus 20 an indicator lamp such as a light emitting diode (LED) that indicates a state related to charging (whether charging is being performed, a remaining battery level, for example). This solution, however, has a great impact on the efforts to provide more compact, thin, and lightweight information processing apparatuses 20. Furthermore, on the information processing apparatus 20 having both a USB port and an AC adapter jack, disposing an indicator lamp is problematic because the USB port and the AC adapter are located apart from each other on the enclosure.

Another possible solution is to provide an indicator lamp to a connector part of each cable 10 on the information processing apparatus 20 side and perform light control of the indicator lamp on the connector part depending on whether the value of a current flowing through a power supply line in the cable 10 has exceeded a predetermined value. This solution turns on the indicator lamp on the connector part when power is being delivered to the information processing apparatus 20 but the information processing apparatus 20 is not being charged. In this case, it is difficult to correctly grasp the state related to charging of the information processing apparatus 20 on the basis of whether the indicator lamp on the connector part turns on. It is therefore desired that a user can identify at a glance a state related to charging of an information processing apparatus 20 on the site.

In view of these circumstances, the present embodiment provides the control system 30 configured to acquire, from the information processing apparatus 20 via the cable 10, information indicating a state related to charging, and perform light control of the indicator lamp on the connector part of the cable 10 on the information processing apparatus 20 side in accordance with the information, thereby allowing a correct grasp of the state related to charging of the information processing apparatus 20.

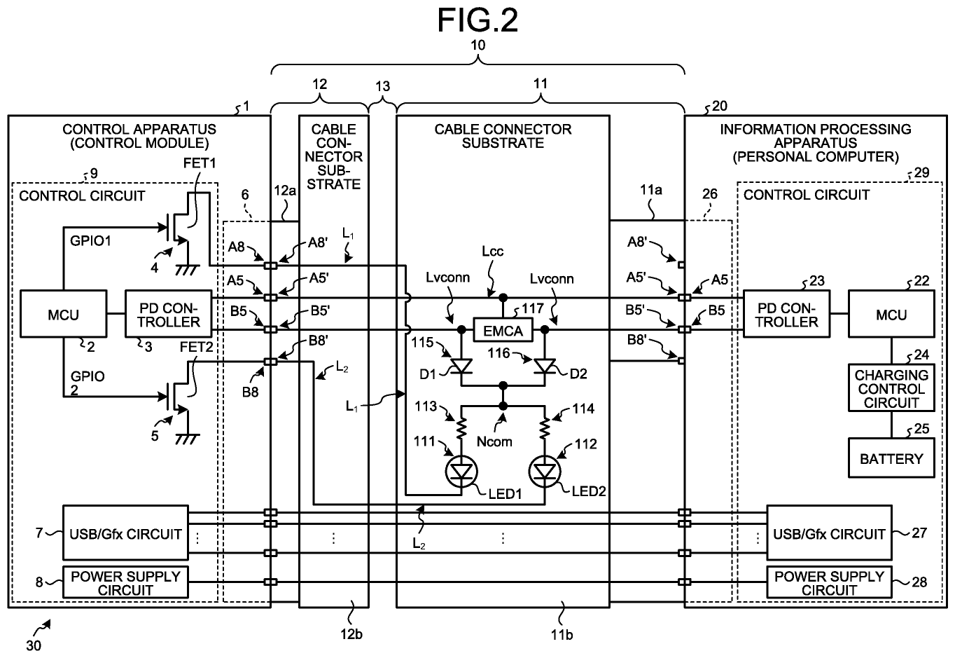

Specifically, the control system 30 includes the control apparatus 1 and the cables 10-1 to 10-n. The cables 10-1 to 10-n correspond to the information processing apparatuses 20-1 to 20-n, respectively. The cables 10-1 to 10-n are connected to the respective information processing apparatuses 20. The control system 30 may be configured as illustrated in FIG. 2. FIG. 2 is a view illustrating a circuit configuration of the control system 30. FIG. 2 illustrates an example configuration in which the control apparatus 1 is connected to one of the information processing apparatuses 20 via the corresponding cable 10.

The cable 10 includes a connector part 11, a connector part 12, and a wire part 13. The connector part 11 is connected to the information processing apparatus 20. The connector part 11 is provided with a plurality of indicator lamps 111 and 112 (refer to FIG. 1B). The connector part 12 is provided on the opposite side of the connector part 11 of the cable 10.

The control apparatus 1 includes an interface part 6 and a control circuit 9. The connector part 12 of the cable 10 is connectable to the interface part 6.

The information processing apparatus 20 includes an interface part 26 and a control circuit 29. The control circuit 29 controls charging of a battery 25 and monitors states related to charging of the battery 25 (whether charging is being performed, a remaining battery level, for example). The control circuit 29 transmits first information and second information to the control apparatus 1 via the interface part 26 and the cable 10 on the basis of a result of the monitoring. The first information is information on whether charging is being performed, for example. The second information is information on a remaining battery level, for example.

The control circuit 9 in the control apparatus 1 acquires, from the information processing apparatus 20 via the cable 10 and the interface part 6, the first information and the second information indicating the states related to charging of the information processing apparatus 20. The control circuit 9 performs light control of the indicator lamp 111 in accordance with the first information and performs light control of the indicator lamp 112 in accordance with the second information.

The control circuit 9 performs light control of the indicator lamp 111 in a lighting mode corresponding to the state indicated by the first information among a plurality of lighting modes and performs light control of the indicator lamp 112 in a lighting mode corresponding to the state indicated by the second information among a plurality of lighting modes.

For example, the control circuit 9 can turn on the indicator lamp 111 to explicitly indicate that the battery 25 in the information processing apparatus 20 is being charged, and turn off the indicator lamp 111 to explicitly indicate that the battery 25 in the information processing apparatus 20 is not being charged. The control circuit 9 can turn on the indicator lamp 112 to explicitly indicate that the level of the battery 25 in the information processing apparatus 20 is equal to or higher than an allowable level (equal to or higher than 50%, for example), and turn off the indicator lamp 112 to explicitly indicate that the level of the battery 25 in the information processing apparatus 20 is lower than the allowable level.

On the cable 10, the indicator lamp 111 includes a light emitting diode (LED) 1, and the indicator lamp 112 includes an LED 2. An anode of the LED 1 is electrically connected to a line LVconn and a cathode thereof is electrically connected to a terminal A8′ in the connector part 12. An anode of the LED 2 is electrically connected to the line LVconn and a cathode thereof is electrically connected to a terminal B8′ in the connector part 12. The line LVconn is provided with a memory storing therein capability information on the cable, and is used as a shared line for supplying constant power to the memory, the LED 1, and the LED 2.

In the control apparatus 1, the interface part 6 includes terminals A8 and B8. The control circuit 9 includes a switch 4 and a switch 5. The switch 4 includes a field effect transistor (FET) 1, and the switch 5 includes an FET 2. The control circuit 9 turns on the switch 4 to connect the terminal A8 to ground potential, and turns off the switch 4 to electrically disconnect the terminal A8 from the ground potential. The control circuit 9 turns on the switch 5 to connect the terminal B8 to ground potential, and turns off the switch 5 to electrically disconnect the terminal B8 from the ground potential.

In addition, the control circuit 9 detects the orientation of the connector part 12 connected to the interface part 6, and on the basis of the detected orientation, maintains the light control of the indicator lamp 111 according to the first information and the light control of the indicator lamp 112 according to the second information.

For example, the interface part 6 includes terminals A5 and B5 in addition to the terminals A8 and B8. The connector part 12 includes the terminals A8′ and B8′ corresponding to the terminals A8 and B8, and terminals A5′ and B5′ corresponding to the terminals A5 and B5.

When the control circuit 9 detects that the terminal A5′ is connected to the terminal A5 and the terminal B5′ is connected to the terminal B5, the control circuit 9 detects that the orientation of the connector part 12 connected to the interface part 6 is the orientation illustrated in FIG. 2. When the connector part 12 is connected to the interface part 6 in the orientation illustrated in FIG. 2, that is, the cathode of the LED 1 is electrically connected to the terminal A8 via the terminal A8′ and the cathode of the LED 2 is electrically connected to the terminal B8 via the terminal B8′, the control circuit 1 performs on/off control of the switch 4 in accordance with the first information to perform light control of the LED 1 and performs on/off control of the switch 5 in accordance with the second information to perform light control of the LED 2. In this manner, the control circuit 9 performs light control of the indicator lamp 111 in accordance with the first information and performs light control of the indicator lamp 112 in accordance with the second information.

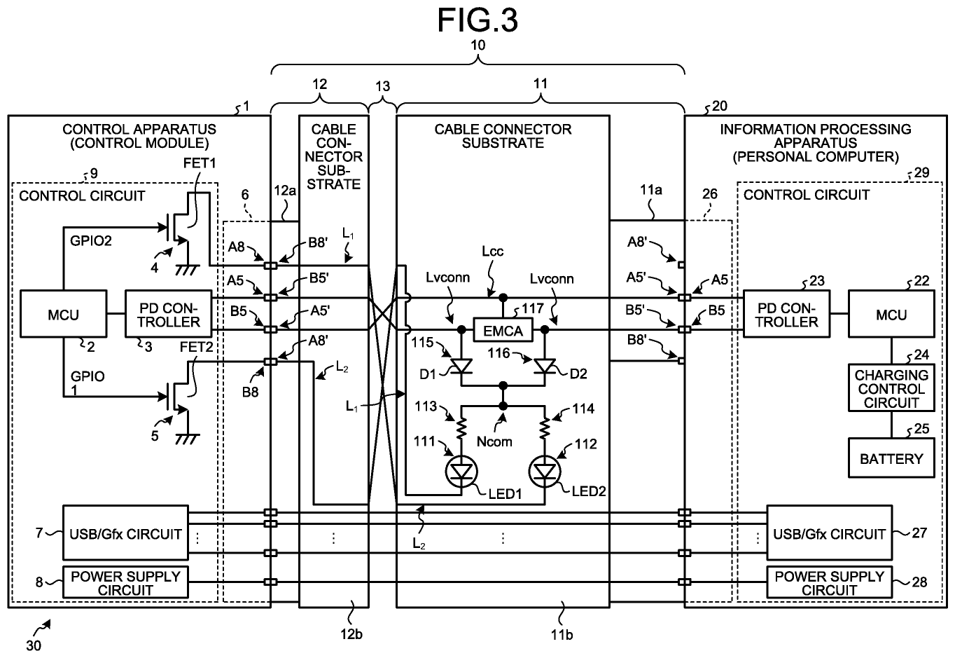

When the control circuit 9 detects that the terminal B5′ is connected to the terminal A5 and the terminal A5′ is connected to the terminal B5, the control circuit 9 detects that the orientation of the connector part 12 connected to the interface part 6 is the orientation illustrated in FIG. 3. When the connector part 12 is connected to the interface part 6 in the orientation illustrated in FIG. 3, that is, the cathode of the LED 1 is electrically connected to the terminal B8 via the terminal A8′ and the cathode of the LED 2 is electrically connected to the terminal A8 via the terminal B8′, the control circuit 1 performs on/off control of the switch 5 in accordance with the first information to perform light control of the LED 1 and performs on/off control of the switch 4 in accordance with the second information to perform light control of the LED 2. In this manner, the control circuit 9 performs light control of the indicator lamp 111 in accordance with the first information and performs light control of the indicator lamp 112 in accordance with the second information.

For example, the control apparatus 1 of the chargeable cabinet 100 acquires the power delivery state and the remaining battery level state of the information processing apparatus 20, and controls the indicator lamps (LEDs, for example) disposed on the connector part of the cable 10. In this case, the cable 10 may be a USB Type-C cable conforming to the USB-C standard. The Type-C Power Delivery (hereinafter referred to as Type-C/PD) specification in the USB-C standard defines a method for communicating over the configuration channel (CC) signal line of a USB Type-C cable by using the Vendor Define Message (VDM) protocol. A USB Type-C connector includes pins called SBU (Side Band Use) (pins SBU1 and SBU2, for example). The control apparatus 1 utilizes the SBU pins for the light control of the indicator lamps. The SBU pins are used to support the DisplayPort function or other functions, and are not mainly used for charging of an information processing apparatus such as by the chargeable cabinet 100. A micro control unit (MCU) is installed in the system of the information processing apparatus 20. The MCU acquires the power delivery state and the remaining battery level state of the information processing apparatus 20 from a charging control circuit (BatteryCharger/FuelGauge) 24, and communicates the acquired states to the control apparatus 1 of the chargeable cabinet 100 via a Type-C/PD Controller (that is, performs VDM communication). In addition, an MCU is installed in the system of the control apparatus 1 of the chargeable cabinet 100. An MCU 2 receives the power delivery state and the remaining battery level state of the information processing apparatus 20 through the VDM communication; connects the pins SBU1 and SBU2 to the ground potential through General Purpose Inputs/Outputs (GPIOs); and connects, to the ground potential, one ends of the indicator lamps 111 and 112 (the cathodes of the LEDs, for example) on the connector part 11 of the cable 10 that are electrically connected to the pins SBU1 and SBU2, thereby controlling the turning on/off of the indicator lamps 111 and 112 (ON/OFF of the LEDs, for example).

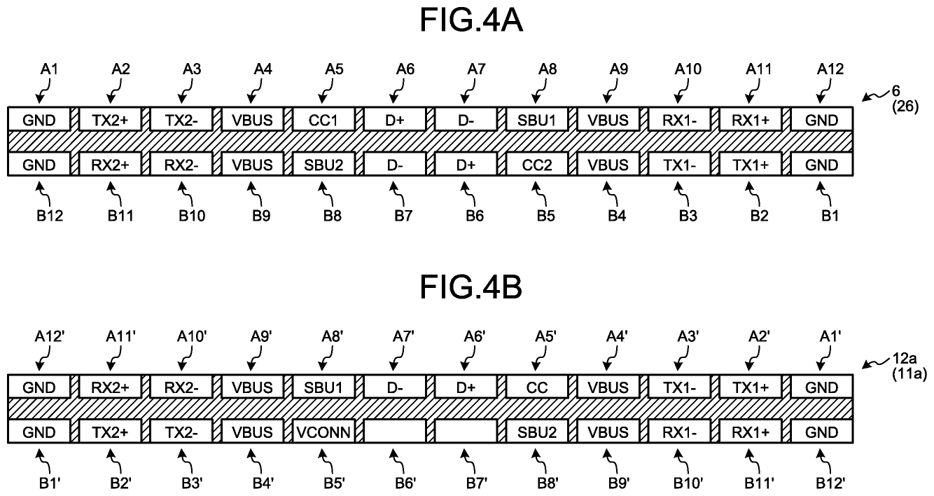

Note that a plurality of indicator lamps 111 and 112 may be disposed on the connector part 11 of the cable 10. An USB Type-C connector is an interface that can be inserted in a reversible manner, and the up/down orientation information is stored in a Type-C/PD Controller 3. Thus, by issuing a query from the MCU 2 to the Type-C/PD Controller 3 in the chargeable cabinet 100, which of the GPIOs is used to control the indicator lamp 111 or 112 can be switched. In the control apparatus 1, the control circuit 9 includes the MCU 2, the PD controller 3, the switch 4, the switch 5, a USB/Gfx circuit 7, and a power supply circuit 8. When the cable 10 is a USB Type-C cable, the interface part 6 includes terminals A1 to Al2 and B1 to B12 conforming to USB Type-C as illustrated in FIG. 4A. FIG. 4A is a view illustrating a terminal configuration of the interface part 6. For example, the terminal A5 is a pin CC1 corresponding to the CC signal line or the constant power supply Vconn line. The terminal B5 is a pin CC2 corresponding to the CC signal line or the constant power supply Vconn line. The terminal A8 is the pin SBU1 used for light control of an indicator lamp. The terminal B8 is the pin SBU2 used for light control of an indicator lamp.

The cable 10 illustrated in FIG. 2 includes the connector part 11, the connector part 12, and the wire part 13. The connector part 11 is a connector part of the cable 10 on the information processing apparatus 20 side. The connector part 12 is a connector part of the cable 10 on the control apparatus 1 side. The wire part 13 interconnects the connector part 11 and the connector part 12.

The connector part 12 includes a connector body 12a and a cable connector substrate 12b. The connector body 12a has a terminal configuration corresponding to the interface part 6, and includes terminals A1′ to A12′ and B1′ to B12′ conforming to USB Type-C as illustrated in FIG. 4B. FIG. 4B is a view illustrating a terminal configuration of the connector part 12 (connector body 12a). For example, the terminal A5′ is a pin CC corresponding to the CC signal line or the constant power supply Vconn line. The terminal B5′ is a pin Vconn corresponding to the constant power supply Vconn line or the CC signal line. The terminal A8′ is the pin SBU1 used to support the DisplayPort function or other functions. The terminal B8′ is the pin SBU2 used to support the DisplayPort function or other functions.

The connector part 11 includes a connector body 11a, a cable connector substrate 11b, the indicator lamp 111, the indicator lamp 112, a resistor element 113, a resistor element 114, a rectifier element 115, a rectifier element 116, and an Electronically Marked Cable Assembly (EMCA) 117. The indicator lamp 111 includes the LED 1, and the indicator lamp 112 includes the LED 2. The rectifier element 115 includes a diode D1, and the rectifier element 116 includes a diode D2.

The connector body 11a has a terminal configuration corresponding to the interface part 26, and includes terminals A1′ to A12′ and B1′ to B12′ conforming to USB Type-C as illustrated in FIG. 4B. For example, the terminal A5′ is a pin CC corresponding to the CC signal line or the constant power supply Vconn line. The terminal B5′ is a pin Vconn corresponding to the constant power supply Vconn line or the CC signal line. The terminal A8′ is the pin SBU1 used for light control of an indicator lamp. The terminal B8′ is the pin SBU2 used for light control of an indicator lamp. The anode of the LED 1 is electrically connected to the constant power supply line LVconn via the resistor element 113, a common node Ncom, and the diode D1 or the diode D2, and the cathode thereof is electrically connected to the terminal A8′ in the connector part 12 via a control line L1. The control line L1 extends from the cable connector substrate 11b to the connector body 12a through the wire part 13 and the cable connector substrate 12b. The anode of the LED 2 is electrically connected to the constant power supply line LVconn via the resistor element 114, the common node Ncom, and the diode D1 or the diode D2, and the cathode thereof is electrically connected to the terminal B8′ in the connector part 12 via a control line L2. The control line L2 extends from the cable connector substrate lib to the connector body 12a through the wire part 13 and the cable connector substrate 12b. A first power supply node of the EMCA 117 is electrically connected to the terminal B5′ in the connector part 12 via the constant power supply line LVconn, and a second power supply node thereof is electrically connected to the terminal B5′ in the connector part 11 via the constant power supply line LVconn. A signal node of the EMCA 117 is connected to the terminal A5′ in the connector part 12 and the terminal A5′ in the connector part 11 via a signal line Lcc.

The information processing apparatus 20 includes the interface part 26 and the control circuit 29. The control circuit 29 includes a detection circuit 21, an MCU 22, a PD controller 23, the charging control circuit 24, the battery 25, a USB/Gfx circuit 27, and a power supply circuit 28. When the cable 10 is a USB Type-C cable, the interface part 26 includes terminals Al to Al2 and B1 to B12 conforming to USB Type-C as illustrated in FIG. 4A. For example, the terminal A5 is a pin CC1 corresponding to the CC signal line or the constant power supply Vconn line. The terminal B5 is a pin CC2 corresponding to the CC signal line or the constant power supply Vconn line. The terminal A8 is the pin SBU1 used to support the DisplayPort function or other functions. The terminal B8 is the pin SBU2 used to support the DisplayPort function or other functions.

More specifically, an interface of the USB Type-C cable 10 generally includes the following three configurations as illustrated in FIG. 2: (1) CC pins for communicating insertion/removal, up/down orientation, and terminal information; (2) a USB and/or Gfx signal circuit; and (3) a power supply circuit. A typical USB Type-C cable 10 does not have an interface that includes an LED and controls the LED depending on a state of the information processing apparatus as described above. Thus, by focusing on the SBU pins of USB Type-C that are not used by the chargeable cabinet 100, a method to control the LED 1 and the LED 2 via the SBU pins is considered as illustrated in FIG. 2. The LED 1 and the LED 2 are provided so that two states (the power delivery state (LED 1) and the remaining battery level state (LED 2), for example) can be represented. A power supply called Vconn is used as the power supply to control the LED 1 and the LED 2. The voltage of a Vbus power supply is variable within a range of 5V to 20V depending on the terminal units connected to both ends of the Type-C cable 10, and thus the V bus power supply is not appropriate to control the LED 1 and the LED 2. The Vconn power supply is basically at 5V, by which the LED 1 and the LED 2 are easier to control. Which of the terminal units connected to the Type-C cable 10 supplies power to the Vconn is not uniquely determined (to be determined by negotiation between the terminal units at both ends). Thus, it is configured that power is allowed to be supplied through both the diode D1 and the diode D2 so that the power can be supplied to the LED 1 and the LED 2 when either of the terminal units supplies the power.

The Type-C cable 10 is also characterized in that it can be connected in a reversible manner. Such connection may be called a forward connection or a reverse connection. The connection illustrated in FIG. 2 indicates the forward connection, and the connection illustrated in FIG. 3 indicates the reverse connection. When the cable is reverse connected as illustrated in FIG. 3, for example, the PD controller (Type-C/PD Controller) 3 can inform the MCU 2 of a forward connection or a reverse connection so that the MCU 2 can recognize that the USB Type-C cable 10 is reverse connected in the case of FIG. 3. In this case, the MCU 2 can cause the LED 1 and the LED 2 to display respective states correctly by reversing the control of a GPIO 1 and a GPIO 2 from the case of a forward connection.

The control of the LED 1 and the LED 2 is performed by the control apparatus 1 of the chargeable cabinet 100. The cathode lines of the LED 1 and the LED 2 serving as signal lines of SBU1 and SBU2 (control lines L1 and L2) are connected to the control apparatus 1 of the chargeable cabinet 100, and the MCU 2 installed in the control apparatus 1 controls gate signals of the FET 1 and the FET 2 through the GPIOs (GPIO 1 and GPIO 2) so as to control the LED 1 and the LED 2.

Upon detecting that the Type-C connectors 12 and 11 are connected, the PD controller 3 and the PD controller 23 start therebetween post processing of connection detection, detects the orientation of the connectors, and determines power supply voltage/current and the direction thereof, the Host/Device relation of USB/DP signals, and other characteristics. This communication starts power delivery from the control apparatus 1 of the chargeable cabinet 100 to the information processing apparatus 20. By taking the start of power delivery as a trigger, the MCU 2 sets the GPIO 1 to “1” (or H level) to turn on the LED 1.

The control of the LED 2 for the remaining battery level state is performed by using the method for communicating over the CC signal line of the USB Type-C cable by using the VDM defined in the Type-C Power Delivery specification, as described above.

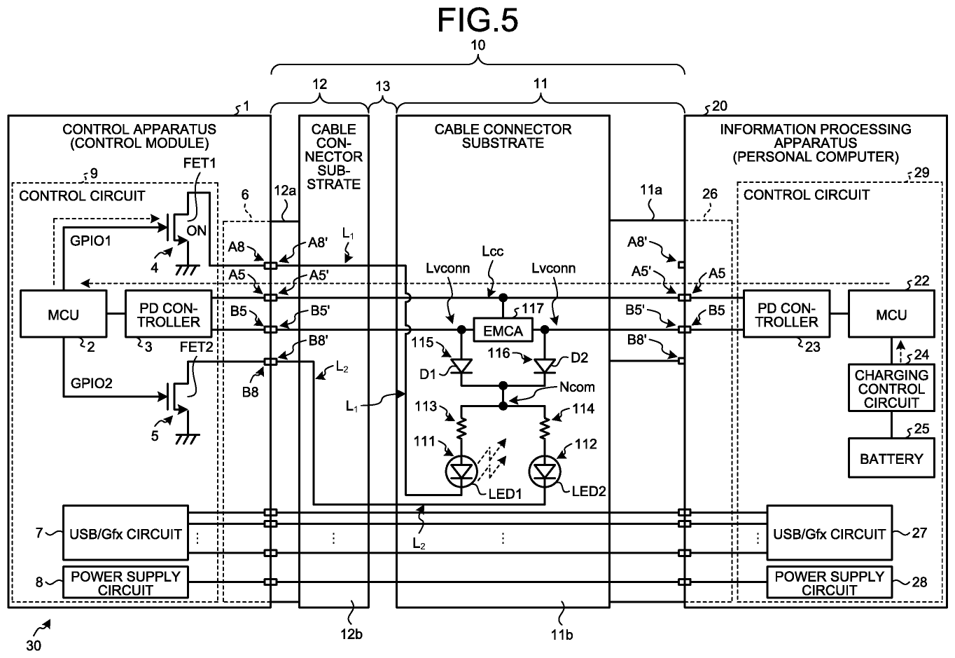

For example, the case of the power delivery state (whether power delivery is being performed) is explained as follows. After the connection detection processing by the Type-C/PDs is completed, the MCU 22 installed in the information processing apparatus 20 communicates with the charging control circuit 24 (typically by an I2C interface) as illustrated in FIG. 5, and starts power delivery to the information processing apparatus 20. In response to the start of power delivery, the MCU 2 performs control to set the GPIO 1 to “1” so as to turn on the switch 4 (FET 1) as illustrated in FIG. 5. With this control, the cathode of the LED 1 is connected to the ground potential via the control line L1, the terminal A8′, the terminal A8, and the switch 4 (FET 1), whereby the LED 1 lights up (turns on).

Note that the light control of the LED 1 may be performed on the basis of the charging state (whether charging is being performed) instead of the power delivery state (whether power delivery is being performed). For example, after the connection detection processing by the Type-C/PDs is completed, the MCU 22 installed in the information processing apparatus 20 communicates with the charging control circuit 24 (typically by an I2C interface) as illustrated in FIG. 5, and stores the charging state on a memory of the MCU 22 periodically. The MCU 22 and the PD controller 23 are connected to each other also typically by an I2C interface. The MCU 22 issues to the PD controller 23 a command that requests the PD controller 23 to transmit the charging state stored on the memory of the MCU 22 to the PD controller 3. The command may be defined by the Type-C/PD Controller specification of each manufacturer. Upon receiving the charging state information on the information processing apparatus 20 from the PD controller 23, the PD controller 3 further transmits the charging state information on the information processing apparatus 20 to the MCU 2 also by an I2C interface. In this manner, the MCU 2 grasps the charging state of the information processing apparatus 20. When charging is started, the MCU 2 performs control to set the GPIO 1 to “1” so as to turn on the switch 5 (FET 2) as illustrated in FIG. 5. With this control, the cathode of the LED 1 is connected to the ground potential via the control line L1, the terminal A8′, the terminal A8, and the switch 4 (FET 1), whereby the LED 1 lights up (turns on). In addition, when the charging is completed, the MCU 2 performs control to set the GPIO 1 to “0” so as to turn off the switch 4. This control turns off the LED 1.

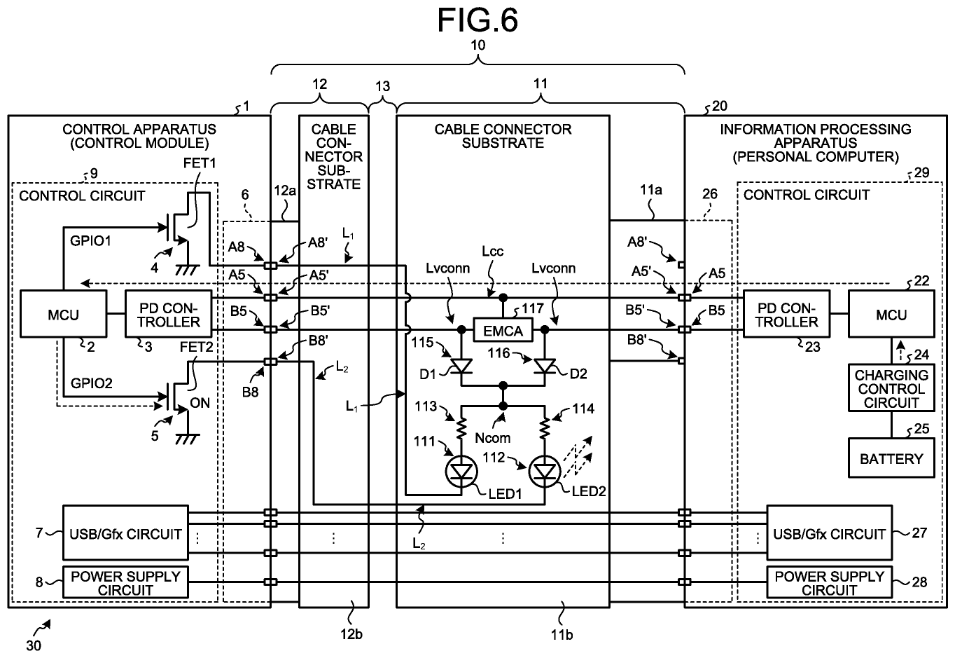

For example, the case of a remaining battery level is explained as follows. After the connection detection processing by the Type-C/PDs is completed, the MCU 22 installed in the information processing apparatus 20 communicates with the charging control circuit 24 (typically by an I2C interface) as illustrated in FIG. 6, and stores the remaining battery level on a memory of the MCU 22 periodically. The MCU 22 and the PD controller 23 are also connected to each other typically by an I2C interface. The MCU 22 issues to the PD controller 23 a command that requests the PD controller 23 to transmit the remaining battery level stored on the memory of the MCU 22 to the PD controller 3. The command may be defined by the Type-C/PD Controller specification of each manufacturer. Upon receiving the remaining battery level information on the information processing apparatus 20 from the PD controller 23, the PD controller 3 further transmits the remaining battery level information on the information processing apparatus 20 to the MCU 2 also by an I2C interface. In this manner, the MCU 2 grasps the remaining battery level of the information processing apparatus 20, and when the remaining battery level reaches a threshold value specified on firmware (FW) of the MCU 2, performs control to set the GPIO 2 to “1” so as to turn on the switch 5 (FET 2) as illustrated in FIG. 6. With this control, the cathode of the LED 2 is connected to the ground potential via the control line L2, the terminal B8′, the terminal B8, and the switch 5, whereby the LED 2 lights up (turns on).

It should be noted that, although the above cases describe the information processing apparatus 20 actively transmitting data to the control apparatus 1 of the chargeable cabinet 100, a method may be used in which the control apparatus 1 of the chargeable cabinet 100 requests data from the information processing apparatus 20 and the information processing apparatus 20 returns the data in response to the request.

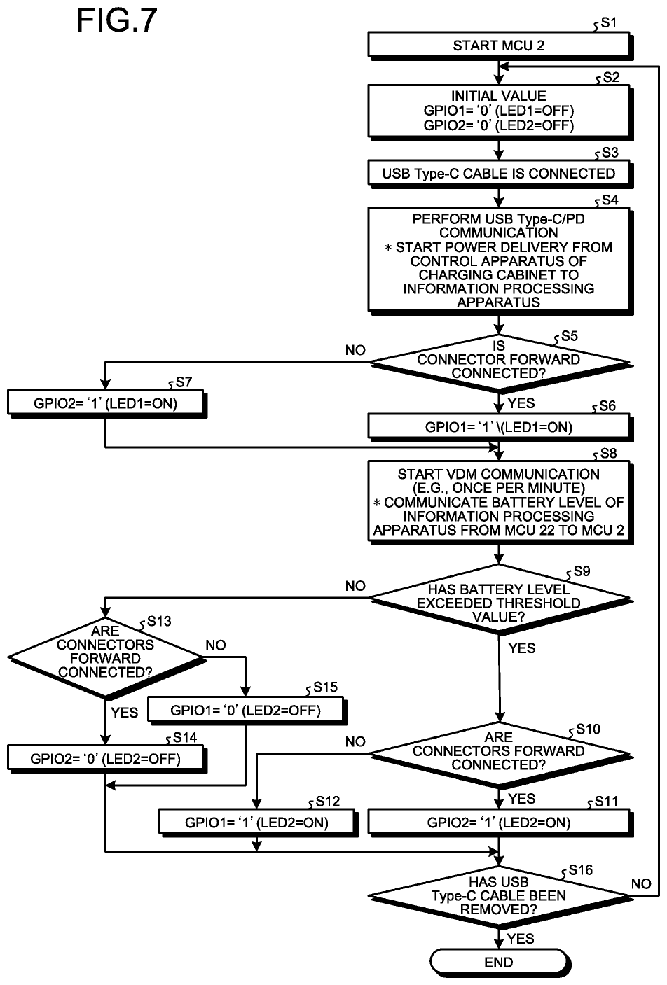

Next, the following describes operation of a control system 30 with reference to FIG. 7. FIG. 7 is a flow chart illustrating the operation of the control system 30.

In the control system 30, the control apparatus 1 starts the MCU 2 (S1), and then sets each of the GPIO 1 and the GPIO 2 of the MCU 2 to “0” (S2) that is an initial value. When the control apparatus 1 detects that a USB Type-C cable is connected (S3), the control apparatus 1 causes the PD controller 3 to communicate with the PD controller 23 and starts power delivery to the information processing apparatus 20 (S4). The control apparatus 1 determines whether a USB Type-C connector is forward connected (S5).

When forward connection is detected (Yes at S5), the control apparatus 1 performs control to set the GPIO 1 to “1” so as to turn on the switch 4 (FET 1) (S6). With this control, the cathode of the LED 1 is connected to the ground potential via the control line L1, the terminal A8′, the terminal A8, and the switch 4, whereby the LED 1 lights up (turns on).

When reverse connection is detected (No at S5), the control apparatus 1 performs control to set the GPIO 1 to “1” so as to turn on the switch 5 (FET 2) (S7). With this control, the cathode of the LED 1 is connected to the ground potential via the control line L1, the terminal A8′, the terminal B8, and the switch 5, whereby the LED 1 lights up (turns on).

Then, the control apparatus 1 performs VDM communication, receives remaining battery level information on the information processing apparatus 20 from the MCU 22 (at a cycle of once per minute, for example) (S8), and determines whether the remaining battery level has reached a threshold value on the basis of the remaining battery level information (S9).

When the remaining battery level has reached the threshold value (Yes at S9), the control apparatus 1 determines whether the USB Type-C connectors are forward connected (S10).

When forward connection is detected (Yes at S10), the control apparatus 1 performs control to set the GPIO 2 to “1” so as to turn on the switch 5 (S11). With this control, the cathode of the LED 2 is connected to the ground potential via the control line L2, the terminal B8′, the terminal B8, and the switch 5, whereby the LED 2 lights up (turns on).

When reverse connection is detected (No at S10), the control apparatus 1 performs control to set the GPIO 2 to “1” so as to turn on the switch 4 (S12). With this control, the cathode of the LED 2 is connected to the ground potential via the control line L2, the terminal B8′, the terminal A8, and the switch 4, whereby the LED 2 lights up (turns on).

When the remaining battery level has not reached the threshold value (No at S9), the control apparatus 1 determines whether the USB Type-C connectors 12 and 11 are forward connected (S13).

When forward connection is detected (Yes at S13), the control apparatus 1 performs control to maintain the GPIO 2 at “0” so as to maintain the switch 5 in the turned off state (S14). With this control, the LED 2 is maintained in the turned off state.

When reverse connection is detected (No at S13), the control apparatus 1 performs control to maintain the GPIO 2 at “0” so as to maintain the switch 4 in the turned off state (S15). With this control, the LED 2 is maintained in the turned off state.

The control apparatus 1 determines whether the USB Type-C connectors 12 and 11 have been removed (S16). When the connectors have not been removed (No at S16), the process returns to S2. When the connectors have been removed (Yes at S16), the process ends.

As described above, according to the embodiment, the control system 30 acquires, from the information processing apparatus 20 via the cable 10, information indicating a state related to charging, and performs light control of an indicator lamp on the connector part of the cable 10 on the information processing apparatus 20 side in accordance with the information. With this configuration, the state related to charging of the information processing apparatus 20 can be correctly grasped. For example, at a school site or other locations, a user can easily check, at hand, that the information processing apparatus 20 stored in a chargeable cabinet can be readily used.

According to the embodiment, the connector part 11 is provided with a plurality of the indicator lamps 111 and 112. The control circuit 9 acquires the first information and the second information from the information processing apparatus 20 via the cable 10 and the interface part 6. The first information indicates one state related to charging of the information processing apparatus 20, and the second information indicates another state related to the charging of the information processing apparatus 20. The control circuit 9 performs light control of the indicator lamp 111 in accordance with the first information and performs light control of the indicator lamp 112 in accordance with the second information. With this configuration, a plurality of different states related to charging can be displayed with a plurality of the indicator lamps 111 and 112.

According to the embodiment, the control circuit 9 performs light control of the indicator lamp 111 in a lighting mode corresponding to the state indicated by the first information among a plurality of lighting modes. With this configuration, the content of the state indicated by the first information can be indicated by a lighting mode used for turning on the indicator lamp 111 among the lighting modes.

According to the embodiment, the control circuit 9 performs light control of the indicator lamp 111 in a lighting mode corresponding to the state indicated by the first information among a plurality of lighting modes and performs light control of the indicator lamp 112 in a lighting mode corresponding to the state indicated by the second information among a plurality of lighting modes. With this configuration, the content of the state indicated by the first information can be indicated by a lighting mode used for turning on the indicator lamp 111 among the lighting modes, and the content of the state indicated by the second information can be indicated by a lighting mode used for turning on the indicator lamp 112 among the lighting modes. Consequently, a plurality of different states related to charging can be displayed with a plurality of the indicator lamps 111 and 112.

According to the embodiment, the indicator lamp 111 includes the LED 1 having the anode connected to the line LVconn, through which constant power is supplied, in the cable 10, and the control circuit 9 supplies constant power to the line LVconn to perform light control of the LED 1. With this configuration, light control of the LED 1 can be performed stably.

According to the embodiment, the interface part 6 includes the terminal A8, and the control circuit 9 includes the switch 4 that connects the terminal A8 to the ground potential. When the cathode of the LED 1 is electrically connected to the terminal A8, the control circuit 9 performs on/off control of the switch 4 to perform light control of the LED 1. With this configuration, the control circuit 9 can perform, from the outside of the cable 10, light control of the LED 1 provided on the connector part 11 of the cable 10.

According to the embodiment, the line LVconn is provided with a memory (EMCA 117) storing therein capability information on the cable 10, and is used as a shared line for supplying constant power to the memory and the LED 1. With this configuration, light control of the LED 1 can be performed at low cost.

According to the embodiment, the control circuit 9 detects the orientation of the connector part 12 connected to the interface part 6, and on the basis of the detected orientation, maintains the light control of the indicator lamp 111 according to the first information and the light control of the indicator lamp 112 according to the second information. With this configuration, a plurality of different states related to charging can be continuously displayed with a plurality of the indicator lamps 111 and 112.

According to the embodiment, the indicator lamp 111 includes the LED 1 having the anode connected to the line LVconn, through which constant power is supplied, in the cable 10, and the indicator lamp 112 includes the LED 2 having the anode connected to the line LVconn. The control circuit 9 supplies constant power to the line LVconn to perform light control of the LED 1 and the LED 2. With this configuration, light control of the LED 1 and the LED 2 can be performed at low cost.

According to the embodiment, the interface part 6 includes the terminal A8 and the terminal B8. The control circuit 9 includes the switch 4 that connects the terminal A8 to the ground potential, and the switch 5 that connects the terminal B8 to the ground potential. When the cathode of the LED 1 is electrically connected to the terminal A8 and the cathode of the LED 2 is electrically connected to the terminal B8, the control circuit 9 performs on/off control of the switch 4 in accordance with the first information to perform light control of the LED 1 and performs on/off control of the switch 5 in accordance with the second information to perform light control of the LED 2. When the cathode of the LED 1 is electrically connected to the terminal B8 and the cathode of the LED 2 is electrically connected to the terminal A8, the control circuit 9 performs on/off control of the switch 5 in accordance with the first information to perform light control of the LED 1 and performs on/off control of the switch 4 in accordance with the second information to perform light control of the LED 2. With this configuration, the light control of the indicator lamp 111 according to the first information and the light control of the indicator lamp 112 according to the second information can be maintained on the basis of the detected orientation.

According to the embodiment, the control system 30 includes the control apparatus 1 and the cable 10. The cable 10 includes the connector part 11 to which the information processing apparatus 20 is connected, and the connector part 12 provided on the opposite side of the connector part 11 and to which the control apparatus 1 is connected. The connector part 11 is provided with the indicator lamps 111 and 112. With this configuration, a user of the information processing apparatus 20 can identify, at a glance, states related to charging of the information processing apparatus 20.

Note that, by replacing the MCU on the chargeable cabinet 100 side with a computer or other devices and performing control at a higher layer (the application layer, for example), it is possible to notify not only the remaining battery level but also whether materials needed for a lesson have been provided, for example. That is, because light control of the indicator lamps on the connector part is performed in accordance with information acquired from the information processing apparatus 20, application can be extended to various states (security, failure, etc.) of the information processing apparatus 20 other than the states related to charging.

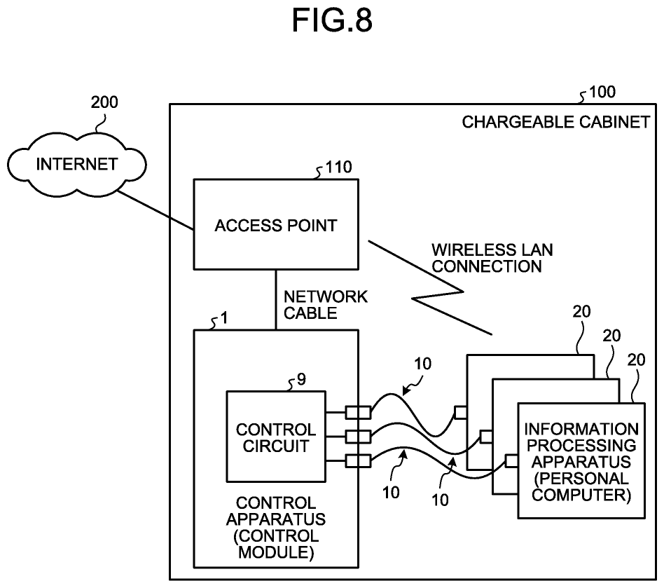

The embodiment describes an example of controlling the remaining battery level of the information processing apparatus 20 by communication between the control apparatus 1 of the chargeable cabinet 100 and the information processing apparatus 20. An access point 110 connected to Internet 200 may be installed in the chargeable cabinet 100 as illustrated in FIG. 8. For example, a security update on the information processing apparatus 20 stored in the chargeable cabinet 100 can be performed over the Internet 200 using wireless LAN connection via the access point 110. The control apparatus 1 can also perform VDM communication to acquire, from the information processing apparatus 20, information on whether the security update has been completed without problem, and cause to turn on an LED on a USB Type-C cable corresponding to the information processing apparatus 20 that has completed the security update without problem so as to notify a user which information processing apparatus 20 has no problem with security.

The above described embodiment describes as an example of the cable 10 including two indicator lamps 111 and 112; however, the number of indicator lamps is not limited to two. There may be one indicator lamp, for example. In this case, the control circuit 9 may control lighting of the indicator lamp depending on whether charging is being performed or not performed, for example. Three or more indicator lamps may be provided on the cable.

The above described embodiment describes an example in which two separately located LED 1 and LED 2 emit light from two separate openings or windows; however, the location of the LED 1 and the LED 2 or other arrangement is not limited to this example. Closely located LED 1 and LED 2 may emit light from the same opening, for example. In this case, by setting that the LED 1 emits red light and the LED 2 emits green light, orange light can be emitted when the LED 1 and the LED 2 are turned on at the same time. With this configuration, three states can be displayed with the two LEDs 1 and 2.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A control apparatus comprising:
an interface part to which a second connector part of a cable is connectable, wherein the cable includes a first connector part and the second connector part, the first connector part is a part to be connected to an information processing apparatus, the second connector part is arranged on an opposite side of the first connector part, a first indicator lamp is disposed on the first connector part; and
a control circuit that acquires, from the information processing apparatus via the cable and the interface part, first information indicating a state related to charging of the information processing apparatus, and performs light control of the first indicator lamp in accordance with the first information.

2. The control apparatus according to claim 1, wherein
a second indicator lamp is further disposed on the first connector part,
the control circuit acquires the first information and second information from the information processing apparatus via the cable and the interface part,
the second information indicates another state related to charging of the information processing apparatus, and
the control circuit performs light control of the first indicator lamp in accordance with the first information, and performs light control of the second indicator lamp in accordance with the second information.

3. The control apparatus according to claim 1, wherein
the control circuit performs light control of the first indicator lamp in a lighting mode corresponding to the state indicated by the first information among a plurality of lighting modes.

4. The control apparatus according to claim 2, wherein
the control circuit performs light control of the first indicator lamp in a lighting mode corresponding to the state indicated by the first information among a plurality of lighting modes, and performs light control of the second indicator lamp in a lighting mode corresponding to the state indicated by the second information among a plurality of lighting modes.

5. The control apparatus according to claim 1, wherein
the first indicator lamp includes a first light emitting diode having an anode connected to a first line in the cable,
constant power is supplied to the first indicator lamp through the first line, and
the control circuit supplies the constant power to the first line to perform light control of the first light emitting diode.

6. The control apparatus according to claim 5, wherein
the interface part includes a first terminal,
the control circuit includes a switch that connects the first terminal to ground potential, and
when a cathode of the first light emitting diode is electrically connected to the first terminal, the control circuit performs on/off control of the switch to perform light control of the first light emitting diode.

7. The control apparatus according to claim 5, wherein
the first line comprises a memory that stores capability information on the cable, and
the first line is used as a shared line for supplying constant power to the memory and the first light emitting diode.

8. The control apparatus according to claim 4, wherein
the control circuit detects an orientation of the second connector part, and based on the detected orientation, maintains light control of the first indicator lamp according to the first information and light control of the second indicator lamp according to the second information.

9. The control apparatus according to claim 4, wherein
the first indicator lamp includes a first light emitting diode having an anode connected to a first line in the cable,
constant power is supplied to the first indicator lamp through the first line,
the second indicator lamp includes a second light emitting diode having an anode connected to the first line, and
the control circuit supplies the constant power to the first line to perform light control of each of the first light emitting diode and the second light emitting diode.

10. The control apparatus according to claim 9, wherein
the interface part includes
a first terminal and
a second terminal,
the control circuit includes
a first switch that connects the first terminal to ground potential and
a second switch that connects the second terminal to ground potential,
when a cathode of the first light emitting diode is electrically connected to the first terminal and a cathode of the second light emitting diode is electrically connected to the second terminal, the control circuit performs on/off control of the first switch in accordance with the first information to perform light control of the first light emitting diode and performs on/off control of the second switch in accordance with the second information to perform light control of the second light emitting diode, and
when the cathode of the first light emitting diode is electrically connected to the second terminal and the cathode of the second light emitting diode is electrically connected to the first terminal, the control circuit performs on/off control of the second switch in accordance with the first information to perform light control of the first light emitting diode and performs on/off control of the first switch in accordance with the second information to perform light control of the second light emitting diode.

11. A control system comprising:
the control apparatus according to claim 1, wherein
a cable includes a first connector part and a second connector part,
an information processing apparatus is connected to the first connector part,
the second connector part is arranged on an opposite side of the first connector part,
the control apparatus is connected to the second connector part, and
a first indicator lamp is disposed on the first connector part.
